(19) United States
(12) Patent Application Publication
(10) Pub. No.: US 2003/0028630 A1
(43) Pub. Date: Feb. 6, 2003

(54) Method and system for processing topology data and geometry data of networks

(76) Inventors: Gerhard Bischof, Vaterstetten (DE); Michael Vogl, Munchen (DE); Christian Alof, Poughkeepsie, NY (US)

Correspondence Address: LERNER AND GREENBERG, P.A., Post Office Box 2480, Hollywood, FL, 33022-2480, US

(21) Appl. No.: 10/210,738

(22) Filed: Jul. 31, 2002

(30) Foreign Application Priority Data
Jul. 31, 2001 (DE) 101 37 574.3

(51) Int. Cl. G06F 15/173

(52) U.S. Cl. 709/223; 709/224

(57) ABSTRACT

A method for transferring data representing a network topology from a first software environment to a second software environment is provided. The data are reformatted for this purpose, since it is assumed that the different software environments support different file formats, as is the case, for example, with customary network design programs or network simulation programs. Furthermore, the data are reorganized before or after the reformatting in such a way that a different mapping of the network topology results. Consequently, the method allows an automatic transfer of network topology data from one software environment into another, even though the two software environments use different data formats and different topology representations.

### BACKGROUND OF THE INVENTION

1. Field of the Invention

The invention relates to a method and a system for processing topology and geometry data of networks which are called network topology data hereinafter.

Printed circuit boards (PCBs) are nowadays developed by using suitable software. By way of example, a PCB layout is created through the use of the software available under the trademark name ALLEGRO from Cadence Design Systems, Inc.. After finishing the layout, the PCB layout is simulated by using another software. A customary software for this simulation is ADVANCED DESIGN SYSTEM (ADS) from Agilent Technologies, Inc..

One problem here is that to date there has been no way of automatically transforming the layout or design of a PCB from one software environment into another. In particular, neither Cadence Design Systems, Inc. nor Agilent Technologies, Inc. provides an interface or automatic solution for transferring the PCB layout. To date this problem has been solved by transferring the PCB layout, i.e. the PCB design, manually from one software into the other. By way of example, the individual structures designed through the use of ALLEGRO have been completely retraced again in the simulation software ADS, or reconstructed by models present in ADS.

A major disadvantage of this procedure is the high time expenditure when transferring the layout. The individual lines have to be manually retraced. Moreover, with this work process, errors can easily arise due to structures to be simulated not being transferred identically into the simulation software and the simulation results thus no longer describing the reality correctly.

### SUMMARY OF THE INVENTION

It is accordingly an object of the invention to provide a method for processing network topology data which overcomes or at least reduces the above-mentioned disadvantages of the heretofore-known methods of this general type.

With the foregoing and other objects in view there is provided, in accordance with the invention, a method for processing network topology data, the method includes the steps of:

extracting, from a data memory, data representing a first mapping of a network topology in a first data format;

generating data representing a second mapping of the network topology, the second mapping being modified according to a given set of rules; and

transferring the data representing the second mapping of the network topology into a data memory in a second data format.

In other words, a method for processing network topology data, includes the following steps: extraction of data from a data memory, which data represent a first mapping of a network topology in a first data format; generation of data which represent a second mapping of the network topology, the second mapping being modified according to a predetermined set of rules; and transfer of the data representing the second mapping of the network topology into a data memory in a second data format.

This method makes it possible to design a network topology, i.e. for example the design of a PCB, through the use of a first software environment, and thereupon to transfer this design automatically into a second software environment, through the use of which the design is simulated. Since a conversion of the data formats takes place, the design software and the simulation software can use different data formats. Moreover, the two software environments can represent the network topology in different ways since a corresponding conversion is carried out through the use of conversion rules that can be defined.

Consequently, a manual transfer of a PCB design from one software environment into the other is obviated, thereby eliminating the existing error sources and the associated time expenditure.

As already indicated, the data in the first data format can be extracted from a data memory assigned to a network design system, wherein the first data format can be defined by the network design system. By way of example, the network design system may be a system implemented by using SKILL as a programming language, and the first data format may be a data format defined through the use of SKILL. In particular, the network design system may be formed by an ALLEGRO system.

Furthermore, the data in the second data format may be transferred into a data memory assigned to a network simulation system, wherein the second data format can be defined by the network simulation system.

By way of example, the network simulation system may be a system implemented in the AEL programming language, and the second data format may be a data format designed through the use of AEL. In particular, the network simulation system may be formed by an ADS system.

Consequently, in one refinement, the invention forms an interface between the ALLEGRO design software and the ADS simulation software.

In one refinement of the invention, the method contains the additional step of the conversion of the data in the first data format into the data of the second data format before the generation of the data representing the second mapping of the network topology. Carrying out the conversion before the generation of the data of the second network topology has the advantage that the step of generation of the data representing the second mapping of the network topology can be implemented in the same programming language as the second software environment (that is to say AEL, for example).

Conversely, the conversion of the data in the first data format into the data of the second data format may also be carried out after the generation of the data representing the second mapping of the network topology. This has the reverse advantage that the step of generation of the data representing the second mapping of the network topology can be implemented in the same programming language as the first software environment (that is to say SKILL, for example).

The network topology may describe a plurality of network elements and network attributes, the network elements containing paths, path segments, pins and/or through-contacts or plated-through holes, and the network attributes containing the length, width and/or position of the paths, path segments, pins and/or through-contacts or plated-through holes. In particular, the pins may contain drivers, connectors, passive clements, bi-directional pins and/or receiver pins.

Preferably, the first data format includes a first set of codes for representing the layers of the abovementioned network topology and the second data format includes a second set of codes for representing the layers of the second network topology, wherein the first set can be combined with the second set of codes. Such a so-called mapping makes it possible to combine the naming of the originating system (that is to say of the network design system, for example) with the naming of the target system (that is to say of the network simulation system, for example) in a simple manner.

Preferably, the second mapping of the network topology represents a loop-free network structure in which pins, through-contacts and branching points form nodes, and path segments and passive elements form edges of the network structure. Such a node- or edge-oriented data structure allows the mapping of a network topology design onto network lists, supported by most customary simulation and propagation time analysis tools, for specifying the structure (geometry and topology) of a network.

Preferably, storage of the data representing the loop-free network structure as a text file additionally takes place. This produces an approximately universal interface to existing simulation and propagation time analysis tools.

According to another mode of the invention, a topology of a printed circuit board (PCB) is represented with the network topology.

The invention furthermore provides a computer program for executing the above-described method on a computer. Such a computer program is preferably implemented in the SKILL programming language, i.e. in the language in which external software packets can be linked to ALLEGRO.

If an integration of the computer program is intended to be integrated into the ADS simulation program, for example, then it is programmed in AEL.

With the objects of the invention in view there is also provided, a computer-readable medium having computer-executable instruction for performing a method which includes the steps of:

extracting, from a data memory, data representing a first mapping of a network topology in a first data format;

generating data representing a second mapping of the network topology, the second mapping being modified according to a given set of rules; and

transferring the data representing the second mapping of the network topology into a data memory in a second data format.

With the objects of the invention in view there is also provided, a data processing system for electronically processing network topology data, including:

a data receiving device configured to receive data from a data memory assigned to a network design system, the data representing a first mapping of a network topology in a first data format;

a data generating device configured to generate data representing a second mapping of the network topology, the second mapping being modified according to a given set of rules; and

a data transfer device configured to transfer the data representing the second mapping of the network topology into a data memory assigned to a network simulation system in a second data format.

In other words, the invention furthermore provides a data processing system for the electronic processing of network topology data, including a data receiving device for receiving data from a data memory assigned to a network design system, which data represent a first mapping of a network topology in a first data format; a data generating device for generating data which represent a second mapping of the network topology, the second mapping being modified according to a predetermined set of rules; and a data transfer device for transferring the data representing the second mapping of the network topology into a data memory assigned to a network simulation system in a second data format.

Also provided is a network development system, having such a data processing system in combination with a network design system and a network simulation system.

In other words, with the objects of the invention in view there is provided, a network development system, including:

a network design system having a data memory assigned thereto;

a network simulation system having a data memory assigned thereto;

a data processing system operatively connected to the network design system and the network simulation system;

the data processing system including a data receiving device for receiving data from the data memory assigned to the network design system, the data representing a first mapping of a network topology in a first data format;

the data processing system including a data generating device for generating data representing a second mapping of the network topology, the second mapping being modified according to a given set of rules; and

the data processing system including a data transfer device for transferring the data representing the second mapping of the network topology into the data memory assigned to the network simulation system in a second data format.

Other features which are considered as characteristic for the invention are set forth in the appended claims.

Although the invention is illustrated and described herein as embodied in a method and a system for processing topology and geometry data of networks, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flow diagram illustrating the sequence of the conversion of network topology data and the transfer from a first into a second software environment in accordance with the invention;

FIG. 2 is a screenshot of an operating interface of the ALLEGRO software illustrating a detail from a PCB developed for a memory circuit;

FIG. 3 is a screenshot of a layout window of the ADS software after an import of the AEL-based program generated;

FIG. 4 is a screenshot illustrating an individual electrical network after the conversion and the import into the simulation software ADS MOMENTUM (layout);

FIG. 5 is a screenshot illustrating an individual electrical network after the conversion and the import into the simulation software ADS SCHEMATIC (schematic); and

FIG. 6 is a block diagram of a network development system according to the invention.

### DESCRIPTION OF THE PREFERRED EMBODIMENTS

One embodiment of the method according to the invention is realized by a software which is programmed with the programming language SKILL from Cadence Design Systems, Inc.. The software generates one or more (macro) files which can subsequently be imported into the ADS simulation software. These files contain instructions in the programming language AEL (Application Extension Language) from Agilent Technologies, Inc..

The software, which can be called up as an autonomous program through the use of a menu within the operating interface of the ALLEGRO design system, determines the design structures or layout structures of a board designed through the use of ALLEGRO. This encompasses both electrical relationships such as connectivity and topology of the connection networks, and geometrical positions and dimensions of components, lines and through-contacts or plated through-holes. These extracted structures are then translated into elements of the AEL programming language, combined to form a macro, and loaded directly into ADS. The structure can subsequently be simulated in ADS.

From a board design, it is possible to select either the entire board, a desired partial region or else just specific networks by mouse clicking or name inputting. The information about the structure of the board, which information is determined by the software, makes it possible, in principle, to create a network list in one of the SPICE formats (Simulation Program With Integrated Circuit Emphasis), as is described in more detail below.

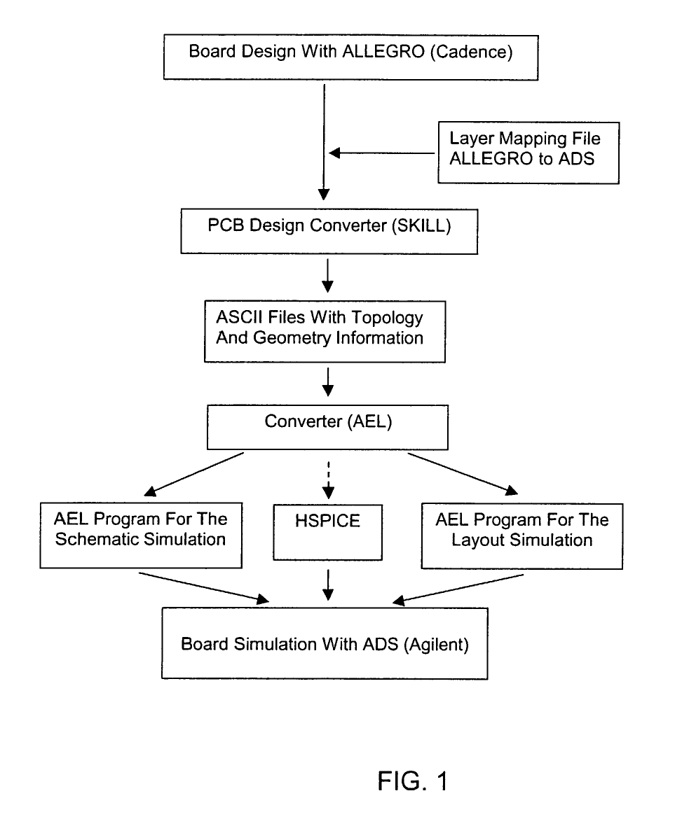

FIG. 1 represents a flow diagram for the board design and the simulation which illustrates the sequence of an automatic transfer of design information through the use of the SKILL programming language into the AEL programming language.

In the following the integration in an ALLEGRO board design system is described. The first part of the software, designated by PCB design converter in the flow diagram, is a program which is implemented in the programming language SKILL and, through the use of this programming language, can readily be integrated in the ALLEGRO board design system available from Cadence Design Systems, Inc.. When the ALLEGRO system is started up, the SKILL code is automatically loaded and held in the memory. The software is called up via a custom submenu that has been anchored in the main menu bar of ALLEGRO. Through the use of the laid-open procedures of the menu interface of ALLEGRO, the user interface of the program appears like a CADENCE tool.

The process of the data extraction is described in the following. The main task of the PCB design converter is the extraction of all the data relevant to a simulation, that is to say the geometry and topology information of the connection networks of the board. By definition, a network connects different pins of logical components in accordance with the circuit diagram (or wiring diagram). The physical representation of a network is formed by the connecting lines which run on different layers of the board and are electrically connected to one another through the use of through-contacts or plated-through holes. Networks end at pins of digital components (direct electrical isolation), while in passive elements there is feedback from the output to the input. This means that both the passive element lying in the signal flow and the network lying at the opposite pin are relevant to a simulation. The conglomerate including passive elements, network at the input pin and network and the output pin is referred to here as an electrical network.

Since the designations of the layers of a board differ in virtually every system, a name conversion is performed. To that end, firstly a text file (in the flow chart: layer mapping file) is read in, which combines the layer names of the ALLEGRO system and of the target system (here the ADS system from Agilent Technologies, Inc.) with one another.

In the ALLEGRO system, networks are substructured into paths. Such paths each include a plurality of segments. Paths are those branches of the network whose end points are pins, through-contacts or branching points. Segments are simple straight line portions and form the smallest units. Using the access functions laid open by Cadence for each network path, end points (pins and through-contacts) and segments with their attributes of length, width and wiring position are extracted directly from the ALLEGRO database and stored in association tables which allow fast access and reorganization of the data.

The data interface is described in the following. The next step of the algorithm performs the definition of the order of the paths according to properties of the pins (driver, connector, passive element, bi-directional pin and receiver pin) and the reorganization of the data into a loop-free graph structure, pins, through-contacts or plated-through holes and branching points forming the nodes, and line portions or else passive elements (such as serial resistors or capacitors) forming the edges. Since this node- or edge-oriented data structure with the storage of geometry and topology of a network virtually ideally maps the structure of the input network lists of almost all simulation and propagation time analysis tools, it is used as a central interface and starting point for all further conversion or generation tools. Owing to its central role, this internal interface can also be generated as a text file. Functions for the writing and reading of this interface can be implemented both in SKILL and in AEL, the procedural language of the ADS system.

The conversion process is performed as follows. In the second part of the conversion operation, the data from the interface described are converted into the matching format of the simulation tool, two different paths can be taken:

1) direct conversion from the internal interface, still within the PCB converter, and

2) indirect conversion via the external interface file, which nonetheless has the same contents, through the use of a component (in the flowchart: converter) which is implemented in the programming language of the ADS system AEL and which, like the PCB design converter, is integrated in the software of the target system ADS.

Finally, as the end result, two macroprograms for the internal simulators of the ADS system are generated, and an interface for the HSPICE simulator is provided. The macros, which can be loaded directly into the system through the use of a command, contain both control commands—such as e.g. “open data window”—and commands which construct structures for a “schematic view” or a “layout view” of one or more networks in the ADS system.

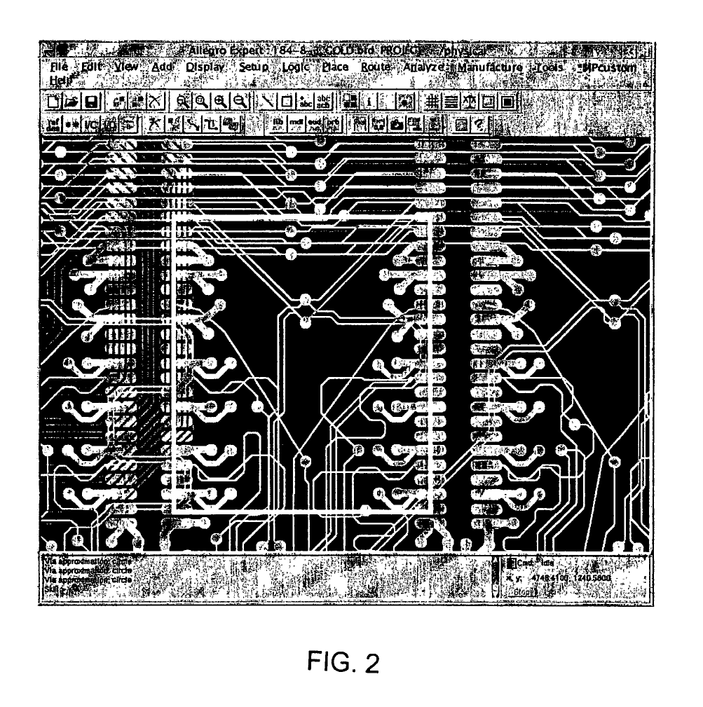

FIG. 2 shows the operating interface of the ALLEGRO software with a detail from a board developed for memory purposes. As mentioned, the program of this embodiment of the invention is automatically loaded into the main memory when ALLEGRO is called up, and can be started via the ALLEGRO menu bar (*MPCustom). There then appears a menu with a plurality of selection possibilities for the selection of networks and the generation of files. Option buttons and associated submenus are used to set details, such as, for example, the selection of models and the generation of ports.

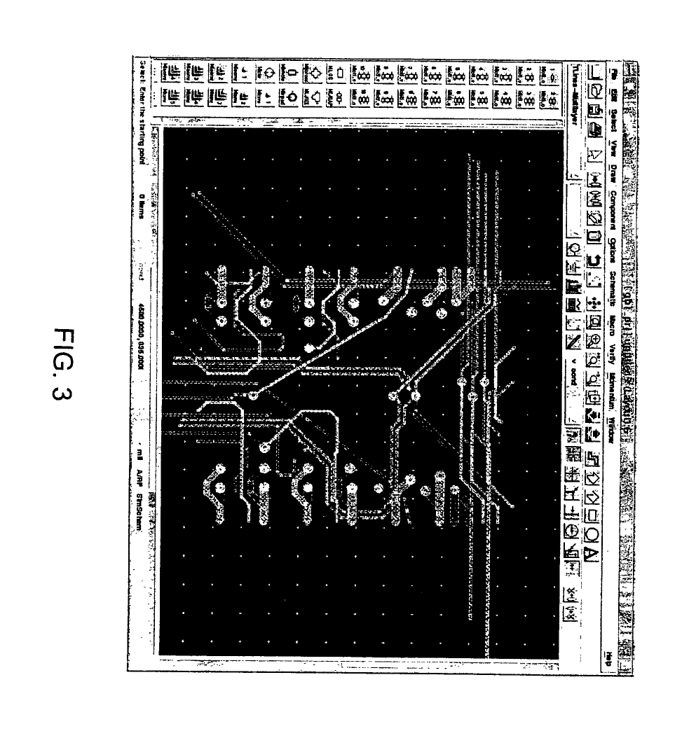

If the region marked in FIG. 2 is selected, then the lines contained therein appear, after the import of the AEL program generated, in the layout window of ADS as represented in FIG. 3.

To carry out a simulation, it is now necessary only to define ports at the line ends or the pins.

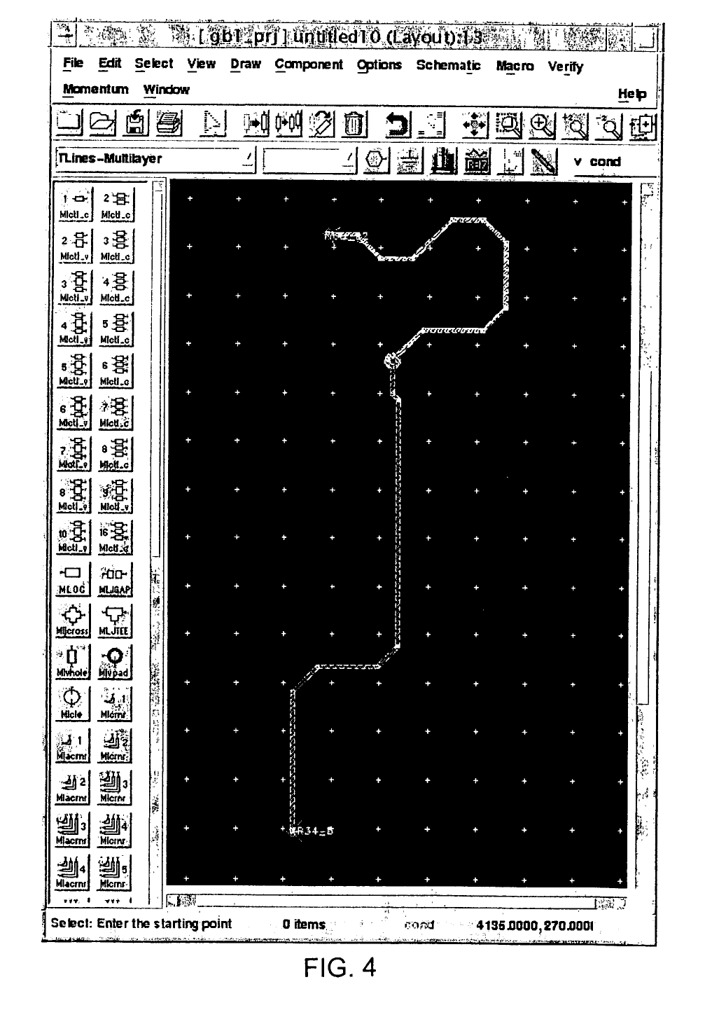

FIG. 4 shows a network converted into the layout editor of ADS. The figure represents lines which run on different layers of the board and are connected to one another by vias (plated-through holes, through-contacts). Ports are added at the positions of the pins in the network.

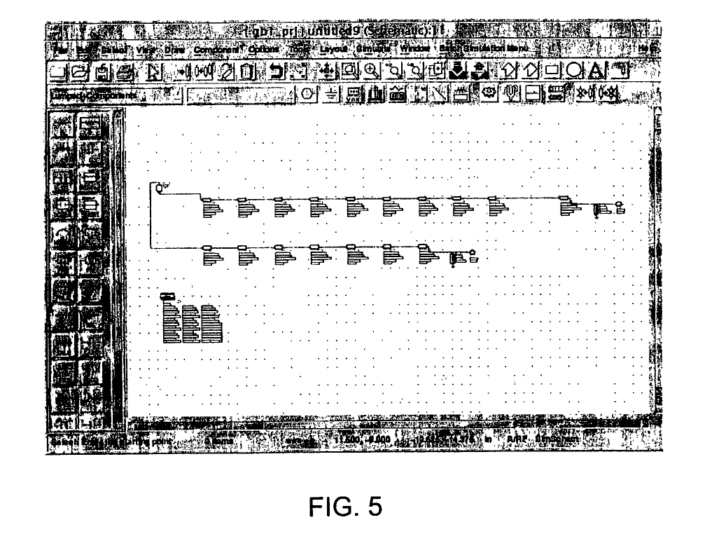

FIG. 5 shows a network converted into the schematic of ADS. In this case, each section of the network (stretch between changes in direction) is assigned a symbol with a corresponding line model. Models are used for vias, too. Furthermore, ports and terminating resistors are added for an S parameter simulation. The substrate (physical construction of the board) is represented by a dedicated symbol.

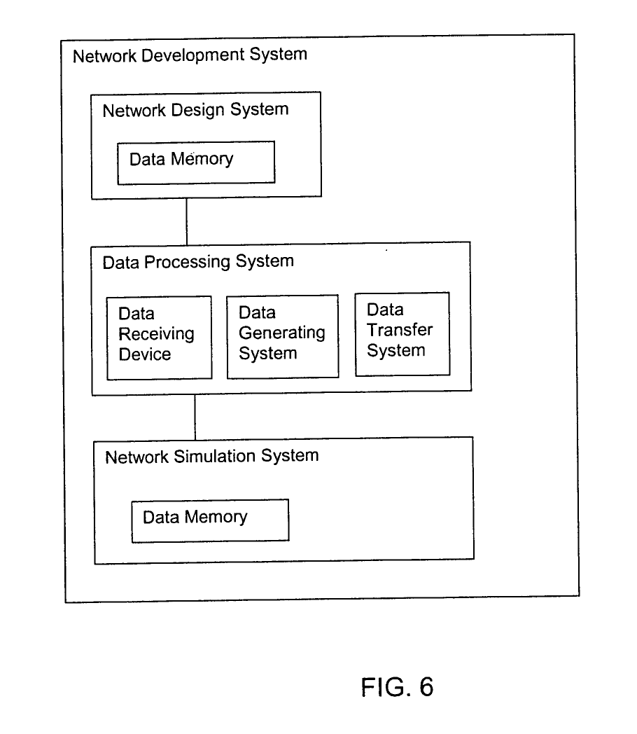

FIG. 6 is a block diagram of a network development system according to the invention. The network development system includes a network design system and a network simulation system. A data memory is assigned to each of the network design system and the network simulation system. The data memories may be embodied as physically separate data memories.

A data processing system is connected to the network design system and the network simulation system. The data processing system includes a data receiving device for receiving data from the data memory assigned to the network design system, the data representing a first mapping of a network topology in a first data format. The data processing system also includes a data generating device for generating data representing a second mapping of the network topology, the second mapping being modified according to a given set of rules. The data processing system further includes a data transfer device for transferring the data representing the second mapping of the network topology into the data memory assigned to the network simulation system in a second data format.

It should be noted that the invention is not limited to the exemplary embodiments described, but rather encompasses modifications in the context of the scope of protection defined by the claims. In particular, the invention can be generally used as an interface between software environments which require a different data formatting and/or representation of a network topology.

We claim:

1. A method for processing network topology data, the method which comprises:
extracting, from a data memory, data representing a first mapping of a network topology in a first data format;
generating data representing a second mapping of the network topology, the second mapping being modified according to a given set of rules; and
transferring the data representing the second mapping of the network topology into a data memory in a second data format.

2. The method according to claim 1, which comprises:
receiving the data in the first data format from a data memory assigned to a network design system; and
defining the first data format by using the network design system.

3. The method according to claim 2, which comprises:
providing the network design system as a system implemented by using SKILL as a programming language; and
providing the first data format as a data format defined by using SKILL as a programming language.

4. The method according to claim 3, which comprises providing the network design system as an ALLEGRO system.

5. The method according to claim 1, which comprises:
transferring the data in the second data format into a data memory assigned to a network simulation system; and
defining the second data format by using the network simulation system.

6. The method according to claim 5, which comprises:
providing the network simulation system as a system implemented by using AEL as a programming language; and
providing the second data format as a data format defined by using AEL as a programming language.

7. The method according to claim 6, which comprises providing the network simulation system as an ADS system.

8. The method according to claim 1, which comprises converting the data in the first data format into the data of the second data format prior to generating the data representing the second mapping of the network topology.

9. The method according to claim 1, which comprises converting the data in the first data format into the data of the second data format subsequent to generating the data representing the second mapping of the network topology.

10. The method according to claim 1, which comprises describing, with the first and second mappings of the network topology, in each case a plurality of network elements and network attributes, the network elements including elements selected from the group consisting of paths, path segments, pins and through-contacts, and the network attributes including attributes selected from the group consisting of a length, a width and a position of the network elements.

11. The method according to claim 10, which comprises providing the pins such that the pins include elements selected from the group consisting of drivers, connectors, passive elements, bi-directional pins and receiver pins.

12. The method according to claim 10, which comprises:
providing the first data format such that the first data format includes a first set of codes for representing layers of the network topology and the second data format includes a second set of codes for representing layers of the network topology; and
combining the first set of codes and the second set of codes.

13. The method according to claim 1, which comprises representing, with the second mapping of the network topology, a loop-free network structure wherein pins, through-contacts and branching points form nodes, and wherein path segments and passive elements form edges of the network structure.

14. The method according to claim 13, which comprises storing data representing the loop-free network structure as a text file.

15. The method according to claim 1, which comprises representing, with the network topology, a topology of a printed circuit board (PCB).

16. The method according to claim 1, which comprises providing the network topology such that the network topology includes information concerning electrical relationships, and geometrical positions and dimensions of components, lines and through-contacts of a network.

17. The method according to claim 1, which comprises providing the network topology such that the network topology includes information concerning a connectivity and a topology of connection networks of a network.

18. The method according to claim 1, which comprises using a computer program on a computer for executing the steps of extracting, generating and transferring.

19. The method according to claim 18, which comprises using SKILL as a computer language for implementing the computer program.

20. The method according to claim 18, which comprises using AEL as a computer language for implementing the computer program.

21. A computer-readable medium having computer-executable instruction for performing a method which comprises:
extracting, from a data memory, data representing a first mapping of a network topology in a first data format;
generating data representing a second mapping of the network topology, the second mapping being modified according to a given set of rules; and
transferring the data representing the second mapping of the network topology into a data memory in a second data format.

22. A data processing system for electronically processing network topology data, comprising:
a data receiving device configured to receive data from a data memory assigned to a network design system, the data representing a first mapping of a network topology in a first data format;
a data generating device configured to generate data representing a second mapping of the network topology, the second mapping being modified according to a given set of rules; and
a data transfer device configured to transfer the data representing the second mapping of the network topology into a data memory assigned to a network simulation system in a second data format.

23. A network development system, comprising:
a network design system having a data memory assigned thereto;
a network simulation system having a data memory assigned thereto;
a data processing system operatively connected to said network design system and said network simulation system;
said data processing system including a data receiving device for receiving data from said data memory assigned to said network design system, the data representing a first mapping of a network topology in a first data format;
said data processing system including a data generating device for generating data representing a second mapping of the network topology, the second mapping being modified according to a given set of rules; and
said data processing system including a data transfer device for transferring the data representing the second mapping of the network topology into said data memory assigned to said network simulation system in a second data format.
